(19) United States
(12) Patent Application Publication
(10) Pub. No.: US 2008/0247713 A1
(43) Pub. Date: Oct. 9, 2008

(54) Optical transmission module and optical patch cable

(75) Inventors: Kenichi Tamura, Hitachi (JP); Yoshiaki Ishigami, Hitachi (JP); Takehiko Tokoro, Hitachi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: HITACHI CABLE, LTD., Tokyo (JP)

(21) Appl. No.: 12/076,527

(22) Filed: Mar. 19, 2008

(30) Foreign Application Priority Data
Apr. 9, 2007 (JP) 2007-101403

(51) Int. Cl. G02B 6/36

(52) U.S. Cl. 385/93; 385/92

(57) ABSTRACT

An optical transmission module includes a ferrule with a built-in optical fiber, an optical member for reflecting or transmitting plural different wavelength optical signals, a first optical element for emitting an optical signal into the optical fiber via the optical member, a second optical element for receiving an optical signal from the optical fiber via the optical member, a package accommodating the first and second optical elements, a circuit substrate for driving the first and second optical elements, the circuit substrate being electrically connected to the package, a case accommodating the package and the circuit substrate, and an inclined portion provided in an inner surface of the case, the circuit substrate being mounted on the inclined portion.

The present application is based on Japanese patent application No. 2007-101403 filed on Apr. 9, 2007, the entire contents of which are incorporated herein by reference.

### BACKGROUND OF THE INVENTION

1. Field of the Invention

The present invention relates to an optical transmission module and an optical patch cable, using an optical fiber to connect between electrical-to-optical and optical-to-electrical signal conversion modules, and transmit and receive optical signals between the modules.

2. Description of the Related Art

In recent years, optical interconnection has been widely used for high-speed transmission of signals in and between system devices, or between optical modules. Namely, the optical interconnection refers to a technique for mounting optical components to a motherboard or a circuit substrate used in personal computers (PCs), vehicles, optical transceivers, and the like, using the optical components in an electrical component manner.

A significant increase in networking signal speed allows optical transmission modules used in such optical interconnection to be used in internal connection of media converters or switching hubs, and in component connection in and between optical transceivers for transmitting Gigabit Ethernet (registered trademark) signals over a short range of a few tens of meters, medical equipment, testing equipment, video systems, high-speed computer clusters, and the like.

For this reason, optical transmission modules used in Infiniband (registered trademark), which is a high-speed interface standard specified for servers, are required to be small in size, and low in cost, and to this end, various researches and developments have been actively done.

In shown in FIG. 13 is a conventional optical transmission module 131.

In the optical transmission module 131 shown in FIG. 13, on a printed wiring board 132 is provided an optical/electrical conversion module 133, which is provided with an optical fiber cable connector 134 at one end of that optical/electrical conversion module 133, and accommodated in a housing 135, which is provided with an electrical plug 136 at one end of that housing 135. This optical transmission module 131 is used by connecting an optical fiber cable to the optical fiber cable connector 134 (See, JP-A-2004-355894, JP-A-2006-309113).

However, the conventional optical transmission module 131 converts + and − electrical signals with the same magnitude to optical signals, and merely transmits into an optical transmission path, i.e., the optical fiber cable, and vice versa.

Namely, because the conventional optical transmission module 131 only performs transmission or reception with one optical fiber, there are the problems of increases in its entire module size, the number of its components, and in its cost, when it is used in Infiniband (registered trademark), which is a high-speed interface standard specified for servers.

Also, optical transmission modules are required to be further enhanced in function, and there is therefore difficulty being equipped with optical or electrical components without increasing module size more than necessary.

In addition, recent optical transmission modules are required to be of a bidirectional communication type simultaneously performing transmission or reception with one optical fiber, but there is no compact multiple/single core product, which maintains transmission at high speed.

### SUMMARY OF THE INVENTION

Accordingly, it is an object of the present invention to provide a small-size and inexpensive optical transmission module and an optical patch cable, which maintain transmission at high speed.

(1) According to one embodiment of the invention, an optical transmission module comprises:

a ferrule comprising a built-in optical fiber;

an optical member for reflecting or transmitting a plurality of different wavelength optical signals;

a first optical element for emitting an optical signal into the optical fiber via the optical member;

a second optical element for receiving an optical signal from the optical fiber via the optical member;

a package accommodating the first and second optical elements;

a circuit substrate for driving the first and second optical elements, the circuit substrate being electrically connected to the package;

a case accommodating the package and the circuit substrate; and

an inclined portion provided in an inner surface of the case, the circuit substrate being mounted on the inclined portion.

(2) According to another embodiment of the invention, an optical transmission module comprises:

a ferrule comprising a built-in optical fiber;

an optical member for reflecting or transmitting a plurality of different wavelength optical signals;

a first optical element for emitting an optical signal into the optical fiber via the optical member;

a second optical element for receiving an optical signal from the optical fiber via the optical member;

a package accommodating the first and second optical elements;

a circuit substrate electrically connected to the first and second optical elements, the ferrule and the optical member being optically coupled each other above the circuit substrate;

a case accommodating the circuit substrate, the ferrule and the optical member, and comprising a box-type lower case with opening at a top thereof, and a sheet-type upper case for covering the opening; and

an inclined portion provided in the lower case, and the circuit substrate being mounted on the inclined portion,

wherein an optical element assembly comprising the first and second optical elements and the package is mounted on the circuit substrate, and the optical member is mounted on the optical element assembly.

In the above embodiment (1) or (2), the following modifications and changes can be made.

(i) The first optical element comprises a transmit optical element array comprising a plurality of parallel-arrayed transmit optical elements for emitting optical signals injected into the optical member, and

the second optical element comprises a receive optical element array comprising a plurality of parallel-arrayed receive optical elements for receiving optical signals emitted from the optical member.

(ii) The optical transmission module further comprises:

a glass substrate; and on the backside thereof

a transmit lens array comprising a plurality of transmit lenses formed to match an array pitch of the transmit optical element array, and a receive lens array comprising a plurality of receive lenses formed to match an array pitch of the receive optical element array,

wherein the transmit lens array, the receive lens array, the transmit optical element array, and the receive optical element array are accommodated in the package.

(iii) The optical transmission module further comprises:

a fiber clip attached to the ferrule, and comprising an engagement groove for engaging a multicore fiber with the case, the engagement groove comprising a clearance.

(iv) The optical transmission module further comprises:

a penetrated hole provided in the circuit substrate positioned beneath the package; and

a heat dissipation member provided in the penetrated hole and in close contact with the backside of the package.

(v) The transmit optical element array and the receive optical element array are arranged opposite each other and mounted in the package.

(vi) The optical transmission module further comprises:

an electromagnetic shield member disposed between the transmit optical element array and the receive optical element array.

(3) According to another embodiment of the invention, an optical patch cable comprises:

a ferrule comprising a plurality of built-in optical fibers,

wherein optical transmission modules are optically connected via the ferrule to both ends respectively of a multicore tape optical fiber comprising a plurality of optical fibers, and

the optical transmission modules each comprise an optical member for reflecting or transmitting a plurality of different wavelength optical signals, a light-emitting element for emitting an optical signal into an optical fiber via the optical member, a light-receiving element for receiving an optical signal from the optical fiber via the optical member, a package accommodating the light-emitting element and the light-receiving element, a circuit substrate for driving the light-emitting element and the light-receiving element, the circuit substrate being electrically connected to the package, and a card edge formed at one end of the circuit substrate.

(4) According to another embodiment of the invention, an optical patch cable comprises:

a ferrule comprising a plurality of built-in optical fibers,

wherein optical transmission modules are optically connected via the ferrule to both ends respectively of a multicore tape optical fiber comprising a plurality of optical fibers, and

the optical transmission modules each comprise an optical member for reflecting or transmitting a plurality of different wavelength optical signals, a light-emitting element for emitting an optical signal into an optical fiber via the optical member, a light-receiving element for receiving an optical signal from the optical fiber via the optical member, a package accommodating the light-emitting element and the light-receiving element, a circuit substrate for driving the light-emitting element and the light-receiving element, the circuit substrate being electrically connected to the package, a card edge formed at one end of the circuit substrate, a case accommodating the package and the circuit substrate, and an inclined portion provided in an inner surface of the case, the circuit substrate being mounted on the inclined portion.

According to this invention, it is possible to provide a small-size and inexpensive optical transmission module, which facilitates mounting of components to a case, and maintains transmission at high speed.

### BRIEF DESCRIPTION OF THE DRAWINGS

The preferred embodiments according to the invention will be explained below referring to the drawings, wherein:

FIG. 1A is a schematic view illustrating a communication system using an optical transmission module in a preferred embodiment according to the invention;

FIG. 1B is a schematic plan view illustrating an essential part of the optical transmission module shown in FIG. 1A;

FIG. 1C is a cross-sectional view illustrating the essential part of the optical transmission module shown in FIG. 1B;

FIG. 2 is a more detailed cross-sectional view illustrating the optical transmission module shown in FIG. 1A;

FIG. 3 is an enlarged cross-sectional view of FIG. 2;

FIG. 4 is a perspective view illustrating coupling of a ferrule of the optical transmission module shown in FIG. 1A and a tape fiber;

FIG. 5 is a cross-sectional view illustrating coupling of the ferrule of the optical transmission module shown in FIG. 1A and the tape fiber;

FIG. 6 is a perspective view illustrating coupling of the ferrule of the optical transmission module shown in FIG. 1A and the tape fiber;

FIG. 7 is a perspective view illustrating an optical member and an optical element assembly of the optical transmission module shown in FIG. 1A;

FIG. 8 is a perspective view illustrating an internal structure of the optical element assembly of the optical transmission module shown in FIG. 1A;

FIG. 9A is a side view illustrating an optical element module;

FIG. 9B is a reverse view illustrating the optical element module of FIG. 9A;

FIG. 9C is a plan view illustrating the optical element module of FIG. 9A mounted on a circuit substrate;

FIG. 10 is a perspective view illustrating an entire configuration of an optical transmission module in an embodiment;

FIG. 11 is a cross-sectional view illustrating one example of the optical transmission module in the embodiment; and

FIG. 12 is a cross-sectional view illustrating an essential part of a modified example of the optical transmission module in the embodiment; and

FIG. 13 is a cross-sectional view illustrating one example of a conventional optical transmission module.

### DETAILED DESCRIPTION OF THE PREFERRED EMBODIMENTS

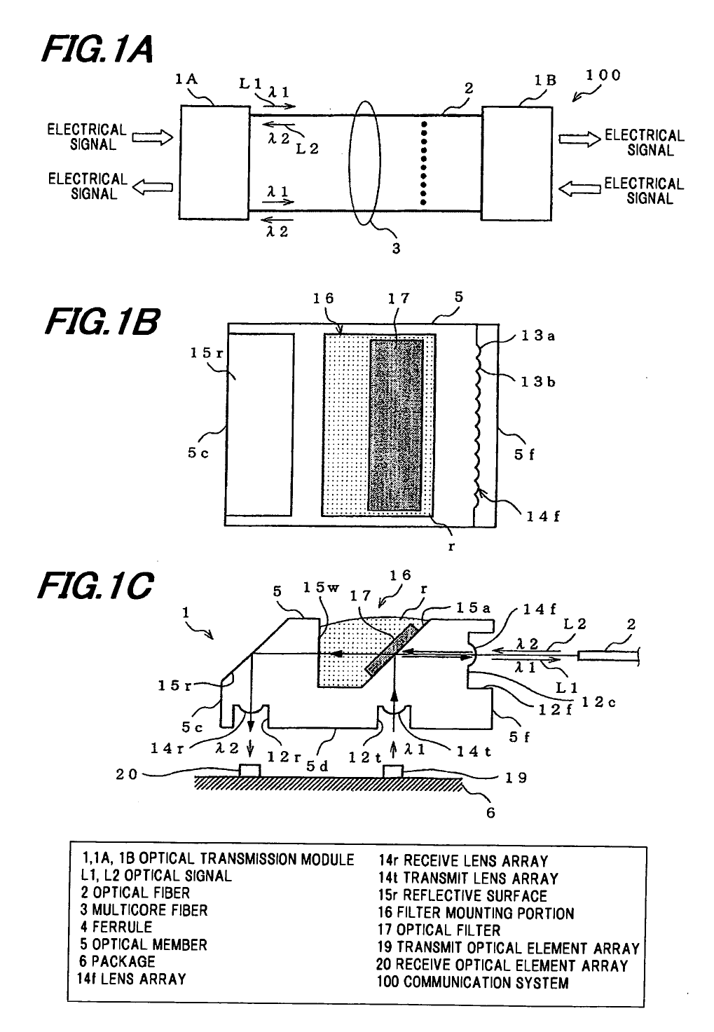

First explained is a communication system using an optical transmission module in a preferred embodiment according to the invention, shown by FIG. 1A.

As shown in FIG. 1A, a communication system 100 connects optical transmission modules (multicore bidirectional optical transmission modules, or active connector modules) 1A and 1B (herein, also referred to as optical transmission module 1) in this embodiment, which convert an electrical/optical to optical/electrical signal, with a multicore fiber 3 comprising plural parallel arrayed optical fibers 2 for transmitting different wavelength optical signals, and converts an electrical/optical to optical/electrical signal, for transmission/reception between the optical transmission modules 1A and 1B.

This embodiment uses twelve multimode fibers (MMFs) as the optical fibers 2, which are arrayed parallel as twelve transmission channels to form a tape fiber which is used as the multicore fiber 3. Used as the different wavelength optical signals transmitted through each optical fiber 2 are a wavelength λ1 optical signal L1 for one optical transmission module 1A, and a wavelength λ2 optical signal L2 for another optical transmission module 1B. By using a vertical cavity surface emitting laser (VCSEL) as a semiconductor laser (LD) that emits around 850 nm wavelength light and is used in a later-mentioned transmit optical element, optical signals L1 and L2 may be used that have a wavelength difference of ±25 nm between their respective wavelengths λ1 (e.g., 825 nm) and λ2 (e.g., 850 nm).

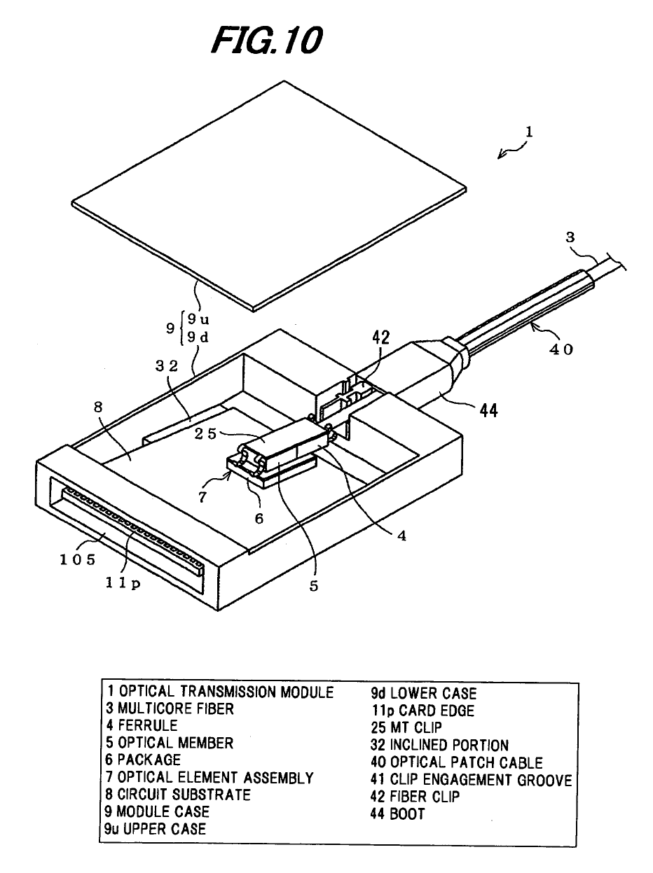

Next explained is an entire configuration of an optical transmission module 1 shown in FIG. 10.

As shown in FIG. 10, the optical transmission module 1 comprises principally a multicore fiber 3, a ferrule 4, an optical member 5, an optical element assembly 7 for accommodating and mounting a transmit optical element and a receive optical element within a ceramic package 6, a circuit substrate (main substrate) 8 for mounting that optical element assembly 7 thereon and being connected to the transmit optical element and the receive optical element, and a module case 9 being open at one end 105.

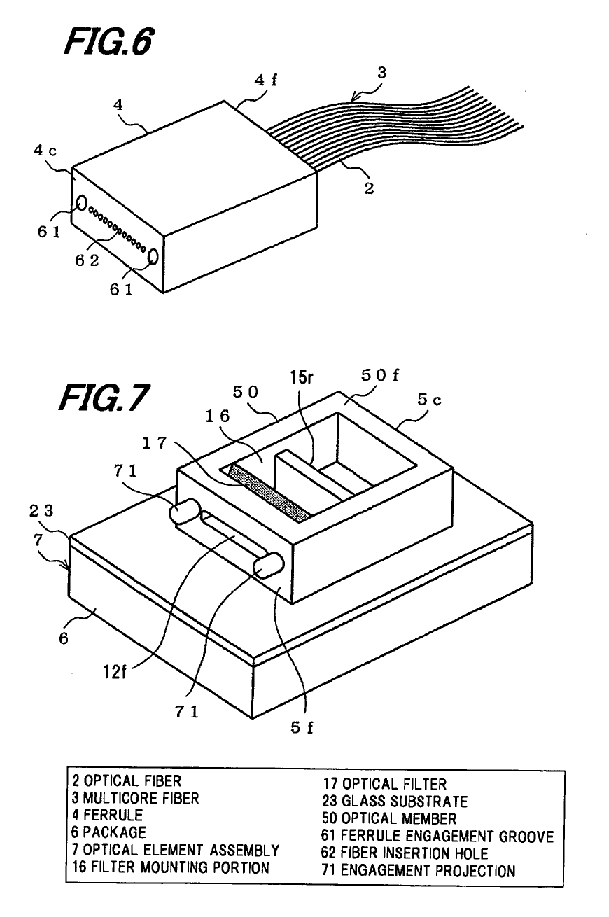

In the ferrule 4 is inserted and incorporated one end (in FIG. 6, the left end) of the multicore fiber 3. Used as the ferrule 4 in this embodiment is an MT (Mechanically Transferable) ferrule.

The optical member 5 is mounted on the optical element assembly 7 and above the circuit substrate 8, for injecting an optical signal from the transmit optical element into an optical fiber inserted in the ferrule 4, or injecting an optical signal from an optical fiber inserted in the ferrule 4 into the receive optical element, for optical coupling of the optical element assembly 7 and the optical fibers.

Namely, as shown in FIG. 1C, the optical member 5 converts the optical paths for optical signal L2 emitted from each optical fiber 2 and optical signal L1 different in wavelength from that optical signal L2 and injected into each optical fiber 2.

On the frontside and backside of one end of the circuit substrate 8 are formed plural connection terminals not shown which constitute a card edge for the substrate. This card edge for the substrate is electrically connected to one end of a connector not shown provided at the one end of the module case 9. On the frontside and backside of the other end of the connector are formed plural connection terminals which constitute a card edge (plug) 11p for the connector. The above device, e.g., a media converter or a high-speed computer is provided with an adapter which engages the card edge 11p, so that the above device is detachably provided with the optical transmission module.

The module case 9 comprises a box-type lower case 9d being open at top, and a sheet-type upper case 9u for covering that opening, and is formed by metal die casting using a high heat dissipative material such as Al, Zn, or the like. The lower case 9d is mounted with the one end of the multicore fiber 3, the ferrule 4, the optical member 5, the optical element assembly 7 and the circuit substrate 8. The lower case 9d is attached and fixed to the upper case 9u with screws.

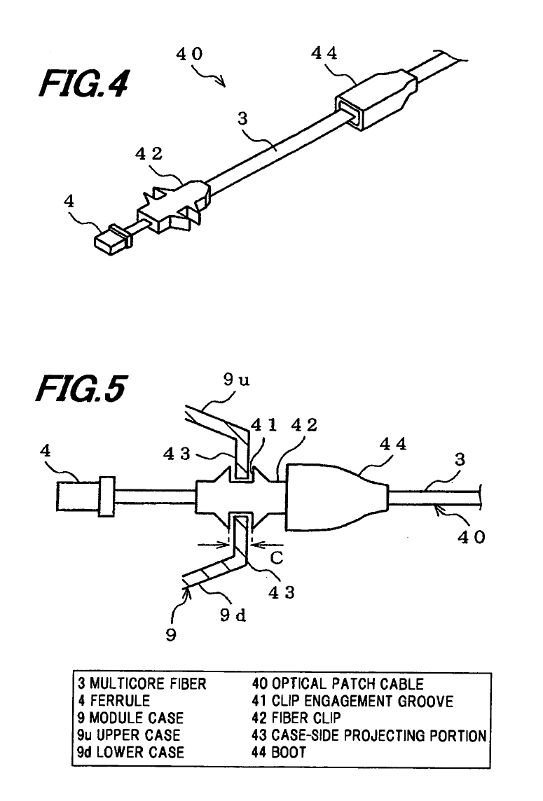

This optical transmission module 1 is optically connected to one end of an optical patch cable 40 for connecting optical transmission modules via the ferrule 4. To the other end of the optical patch cable 40 is optically connected another optical transmission module not shown. The optical patch cable 40 is an optical cable for connecting a relatively short distance (a few meters) between devices. The optical patch cable 40 will be explained in detail with FIGS. 4 and 5 later.

Here, the optical member 5, which is the essential part of the optical transmission module 1, is explained in more detail.

FIG. 1B is a schematic plan view illustrating the essential part of the optical system connection structure in this embodiment, and FIG. 1C is a cross-sectional view thereof.

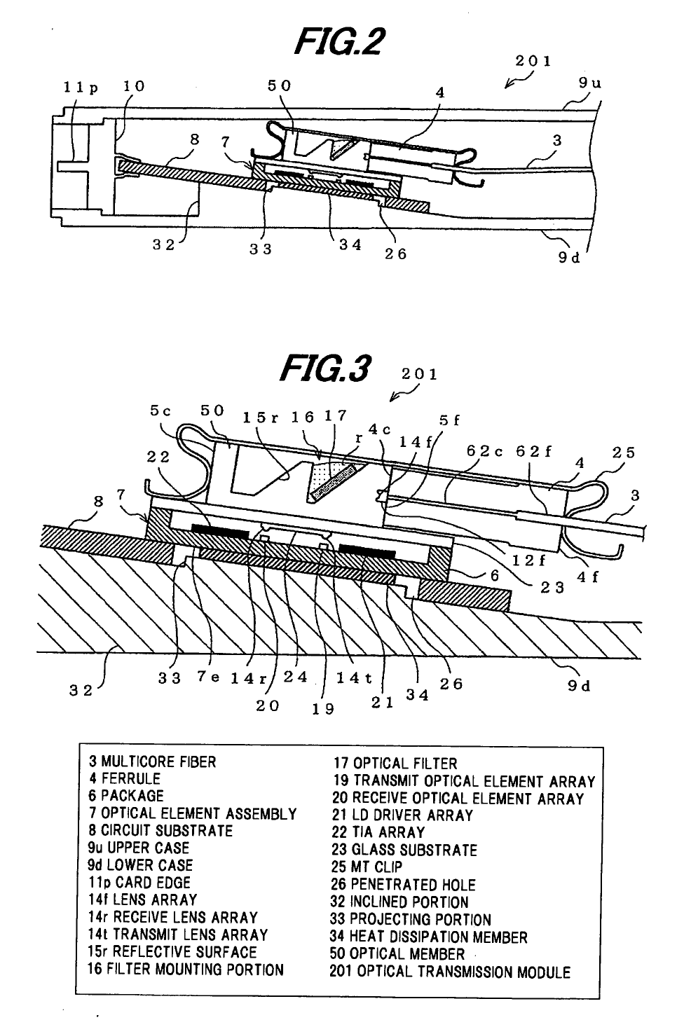

As shown in FIGS. 1B and 1C, on the fiber side of the optical member 5 is formed a fiber-side end face (or a fiber-side light injection/emission end face) 5f which faces one end face of each optical fiber 2 (one end face of the ferrule 4 shown in FIG. 2) which constitutes the multicore fiber 3. In the fiber-side end face 5f of the optical member 5 is formed a fiber-side recessed groove 12f. In a bottom 12c of the recessed groove 12f is formed a lens array 14f for the fiber which comprises plural lenses 13a, 13b, . . . for the fiber optically connected to each optical fiber 2 of the multicore fiber 3, and formed to match an array pitch of the fibers 2.

In substantially the middle on the optical member 5 is formed a substantially recessed (substantially trapezoidal cross-section) filter mounting portion 16 which has a filter mounting surface 15a on the fiber-side end face 5f side of the optical member 5 which is one of at least 2 inclined surfaces inclined at substantially 45° to the optical axis of the fibers 2. On the filter mounting surface 15a is adhesive-mounted one optical filter 17 which reflects optical signal L1 to inject into optical fiber 2 inserted in the ferrule 4 (see FIG. 2), while transmitting optical signal L2 emitted from optical fiber 2 inserted in the ferrule 4.

The optical filter 17 is for reflecting optical signals in a specified wavelength band, but transmitting optical signals in other wavelength bands. In this embodiment, used as the optical filter 17 is an optical filter comprising a dielectric multilayer film to reflect wavelength λ1 optical signal L1, while transmitting wavelength λ2 optical signal L2.

The filter mounting portion 16 mounted with the optical filter 17 may be potted with resin r transparent to optical signals L1 and L2, to cover the optical filter 17, preferably to impregnate the filter mounting portion 16.

Used as this transparent resin r is a UV (ultraviolet)- and heat-cured resin. Its resin material is epoxy-, acryl-, silicon-based resin or the like. The same material is also applied to above-mentioned adhesive for mounting the optical filter 17.

As the other of the at least 2 inclined surfaces inclined at substantially 45° to the optical axis of the fibers 2, a reflective surface 15r, which reflects optical signal L2 emitted from the optical fiber 2 inserted in the ferrule 4 and transmitted through the optical filter 17, is formed in the other end face (the connector-side end face opposite the fiber side) 5c of the optical member 5.

The reflective surface 15r is in contact with material substantially different in refractivity from the optical member 5 or material greater in reflectivity than the optical member 5 and thereby allows substantially total reflection (not less than 95% reflection) of optical signal L2. In this embodiment, the material substantially different in refractivity from the optical member 5 is outside air, but may, besides outside air, also use a Au-metallized mirror, for example.

The package 6 is formed with an opening at its top, and on its inside bottom facing that opening are mounted a transmit optical element array 19 comprising plural parallel-arrayed (array pitch 250 μm) transmit optical elements (e.g., laser diode (LD) elements) for emitting optical signal L1 injected into the optical member 5, and a receive optical element array 20 comprising plural parallel-arrayed (array pitch 250 μm) receive optical elements (e.g., photodiode (PD) elements) for receiving optical signal L2 emitted from the optical member 5.

In this embodiment, according to the number of optical fibers 2 constituting the multicore fiber 3, used as the transmit optical element array 19 is a vertical cavity surface emitting laser (VCSEL) array comprising twelve LD elements, while used as the receive optical element array 20 is a PD array comprising twelve PD elements.

In one-end side bottom (optical element side end face, or optical element side injection/emission surface) 5d of the optical member 5 is formed one optical element side recessed groove 12t. In the inside upper surface of the recessed groove 12t is formed a transmit lens array 14t comprising plural (in this embodiment, twelve lenses) transmit lenses formed to match an array pitch of the transmit optical element array 19.

In the other-end side bottom 5d of the optical member 5 is formed the other optical element side recessed groove 12r. In the inside upper surface of the recessed groove 12r is formed a receive lens array 14r comprising plural (in this embodiment, twelve lenses) receive lenses formed to match an array pitch of the receive optical element array 20.

In the optical member 5, forming the lens array in the inside upper surfaces of the recessed grooves 12t and 12r allows the lens surface to be not in contact with a tray on which the optical member 5 is arranged and placed in a manufacturing assembling process, and to be therefore protected, which facilitates handling of the optical member 5.

This optical member 5 is formed collectively by plastic cast molding with an optical resin transparent to optical signals L1 and L2. Its optical resin material is an acryl-, PC (polycarbonate)-, COP (cycloolefin polymer)-based resin, or the like. Also, to enhance material strength or heat resistance, PEI (polyetherimide), which is super-engineering plastic, is preferable. Any of these optical resins may be used as the optical member 5 in this embodiment. In this case, the optical member 5 material may use a 1.45-1.65 refractivity optical resin, but is not necessary to be limited thereto if there is little optical signal loss.

Here, the optical transmission module 1 is explained in more detail using FIGS. 2, 3 and 9A-9C.

As shown in FIGS. 2 and 3, on the inside bottom of the package 6 are mounted an LD driver array 21 for driving each LD element of the transmit optical element array 19, and a TIA (transimpedance amplifier) array 22 for amplifying an electrical signal received from each PD element of the receive optical element array 20. To the top of the package 6 is attached a glass substrate 23 for sealing the package 6. And, the glass substrate 23 and the package 6 are joined and sealed using resin.

It should however be noted that, shown in FIGS. 2 and 3 is an optical member 50 which is a modification of the optical member 5 of the optical module 1 of FIGS. 1B and 1C, and therefore an optical module 201. This optical member 50 is separate from the transmit lens array 14t and the receive lens array 14r.

When using this optical member 50, on the lower side (backside) of the glass substrate 23 directly above the transmit optical element array 19 and the receive optical element array 20 is provided an optical element-side lens array 24 with the transmit lens array 14t and receive lens array 14r formed integrally. Using the same material as the optical member 50, the optical element-side lens array 24 is also formed collectively by plastic cast molding.

One end face 5f of the optical member 50 and the other end face (the ferrule-side light injection/emission surface) 4c of the ferrule 4 are formed planar such that their height direction (in FIG. 2, vertical direction) is parallel to the normal of the optical axis of the optical fiber 2. The one end face 5f of the optical member 50 and the other end face 4c of the ferrule 4 are optically coupled end to end, in which state the other end face 5c of the optical member 50 and one end face 4f of the ferrule 4 are clipped from both their sides by an MT clip 25 attached from above, so that the optical member 50 and the ferrule 4 are fixed integrally.

In the package 6 formed of ceramics are accommodated and mounted the transmit optical element array 19, receive optical element array 20, LD driver array 21, and TIA array 22, and to the lower side of the glass substrate 23 is adhesive-mounted the optical element-side lens array 24. Subsequently, the glass substrate 23 is placed on the package 6, to accommodate the optical element-side lens array 24 within the package 6, and resin-seal the package 6 and the glass substrate 23, which results in the optical element assembly 7. The outer size of the optical element assembly 7 is approximately 1 cm (width)×1 cm (length). The optical element assembly 7 and the optical member 50 constitute a transmit/receive optical sub-assembly (OSA).

Subsequently, as shown in FIGS. 9A and 9B, to the lower side (backside) of the package 6 is attached plural lattice-arranged solder balls 91 for mounting the optical element assembly 7 on the circuit substrate 8. That is, the package 6 constitutes BGA (Ball Grid Array) solder. The plural solder balls 91 serve partially as ground for the package, to electrically connect the ground for the package and ground for the substrate formed on the circuit substrate 8.

In FIGS. 2 and 3, as methods for attaching and connecting the optical element assembly 7 to the circuit substrate 8, other than the method using BGA solder, there is also a method conductive adhesive-bonding, or bonding-wire-connecting the lower side of the package 6 and the circuit substrate 8.

When conductive adhesive-bonding the lower side of the package 6 and the circuit substrate 8, to electrically transmit a signal on each channel between the package 6 and the circuit substrate 8, each channel between the package 6 and the circuit substrate 8 is electrically connected by wire bonding. Accordingly, in the package 6 is partially formed a region for wire bonding (not shown).

Further, as shown in FIG. 3, the optical element module mounting portion 7e of the circuit substrate 8 on which the package 6 is positioned is provided with a penetrated hole 26 for heat dissipation which partially exposes the lower side of the package 6.

The penetrated hole 26 may be impregnated or provided with a thermal conduction member to enhance heat dissipation. The thermal conduction member may be a thermal conduction sheet comprising silicon resin, or a carbon material, or a metallic member with good thermal conduction.

On the other hand, as shown in FIG. 2, the lower case 9d is provided with an inclined portion 32, the other end side (the connector 10-side opposite the fiber side) inside bottom of which is higher than the fiber-side inside bottom. On the inclined portion 32 is mounted the circuit substrate 8. On the circuit substrate 8 is mounted the optical element assembly 7. On the optical element assembly 7 is mounted the optical member 50.

The inclined portion 32 is formed with a projecting portion 33 which projects into the penetrated hole 26 of the circuit substrate 8. Between the projecting portion 33 and the backside of the package 6 is provided a heat dissipation member 34 in close contact therewith. Used as the heat dissipation member 34 is a thermal conduction sheet formed in a sheet shape by mixing conductive filler into a silicon resin.

Also, as shown in FIGS. 4 and 5, in the optical patch cable 40, to one end side multicore fiber 3 of the ferrule 4 is attached a fiber clip 42 having a clip engagement groove 41 for engagement of the multicore fiber 3 with the module case 9, in a position apart from the ferrule 4 by a specified length. By engagement of the clip engagement groove 41 of the fiber clip 42 with case-side projecting portions 43, 43 provided to the other ends of the lower case 9d and the upper case 9u respectively, the multicore fiber 3 is engaged with the module case 9. This clip engagement groove 41 is provided with clearance C.

This clearance C allows compensating for a surplus length of the multicore fiber 3 between the ferrule 4 and the fiber clip 42, within the module case 9.

In this embodiment, the upper case 9u and the lower case 9d are 0.8 mm thick, and the clip engagement groove 41 is 1.8 mm wide, and the clearance C is therefore on the order of 1 mm.

To the multicore fiber 3 is further attached a boot 44. This boot 44 protects the fiber clip 42 and its adjacent multicore fiber 3 from local bend.

Next explained in detail are the ferrule 4 and the optical member 50 using FIGS. 6 and 7 respectively.

As shown in FIG. 4, the entire ferrule 4 is formed in a substantially parallelepiped shape, and on both sides of its one end face 4c are formed ferrule engagement grooves 61, 61 as engaged portions for being mechanically engaged with the optical member 50. Between these ferrule engagement grooves 61 and 61 are formed plural (in FIG. 6, twelve holes) parallel arranged fiber insertion holes 62 in the ferrule 4 penetrated in the optical axis direction of the optical fibers 2 from one end face 4c to the other end face 4f. The fiber insertion holes 62 are formed at the same array pitch as that of lenses 13a, 13b, . . . for each fiber, to face lenses 13a, 13b, . . . respectively of the above-mentioned lens array 14f for the fiber.

The fiber insertion holes 62 shown in FIG. 6 comprise a large-diameter accommodation portion 62f formed at one end of the ferrule 4 for accommodating the sheath-unremoved multicore fiber 3, and a small-diameter accommodation portion 62c formed at the other end of the ferrule 4 for accommodating each sheath-removed optical fiber 2.

To attach the multicore fiber 3 to the ferrule 4, the sheath of the multicore fiber 3 is first partially removed to undo each optical fiber 2, followed by vertical cutting of one end face of each optical fiber 2 to form a vertical cut surface thereof. Thereafter, the multicore fiber 3 is inserted into the fiber insertion holes 62 until the vertical cut surface of each optical fiber 2 substantially coincides with one end face 4c of the ferrule 4. This is followed by fixing with resin the multicore fiber 3 in the fiber insertion holes 62. Each optical fiber 2 may protrude slightly (on the order of 0.2 mm) from one end face 4c of the ferrule 4 or be recessed slightly into the ferrule 4.

Namely, the length of each optical fiber 2 protruding from one end face 4c of the ferrule 4 may be such that it is not in contact with the lens array 14f for the fiber shown in FIG. 1C, and that the optical coupling loss with the lens array 14f for the fiber is within a desired range. Also, the length from one end face 4c of the ferrule 4 to the end face of each optical fiber 2 recessed into the ferrule 4 may be such that the optical coupling loss with the lens array 14f for the fiber is within a desired range.

Undoing each optical fiber 2 is followed by inserting one end of each optical fiber 2 into the fiber insertion holes 62, and vertically cutting the one end of each optical fiber 2 protruding from the fiber insertion holes 62 to form a vertical cut surface of each optical fiber 2 which coincides with one end face 4c of the ferrule 4.

As shown in FIG. 7, the optical member 50 is formed in substantially the same outer shape as the ferrule 4, and in its one end face 5f are formed engagement projections 71, 71 as engaged portions for being mechanically engaged with the ferrule engagement grooves 61, 61 (see FIG. 6).

This results in coupling portions (connection portions) of the engagement projections 71, 71 and the ferrule engagement grooves 61, 61 engaged with each other. The engagement of the engagement projections 71, 71 and the ferrule engagement grooves 61, 61 causes one end face 5f of the optical member 50 and one end face 4c of the ferrule 4 to be connected end to end to optically couple each optical fiber 2 and the optical member 50.

On the optical member side may be formed engagement grooves as engaged portions, and on the ferrule side may be formed engagement projections as engaged portions.

An upper edge of the optical member 50 is a square frame planar portion 50f for being gripped by a collet chuck of a mounter mounting optical or electrical components.

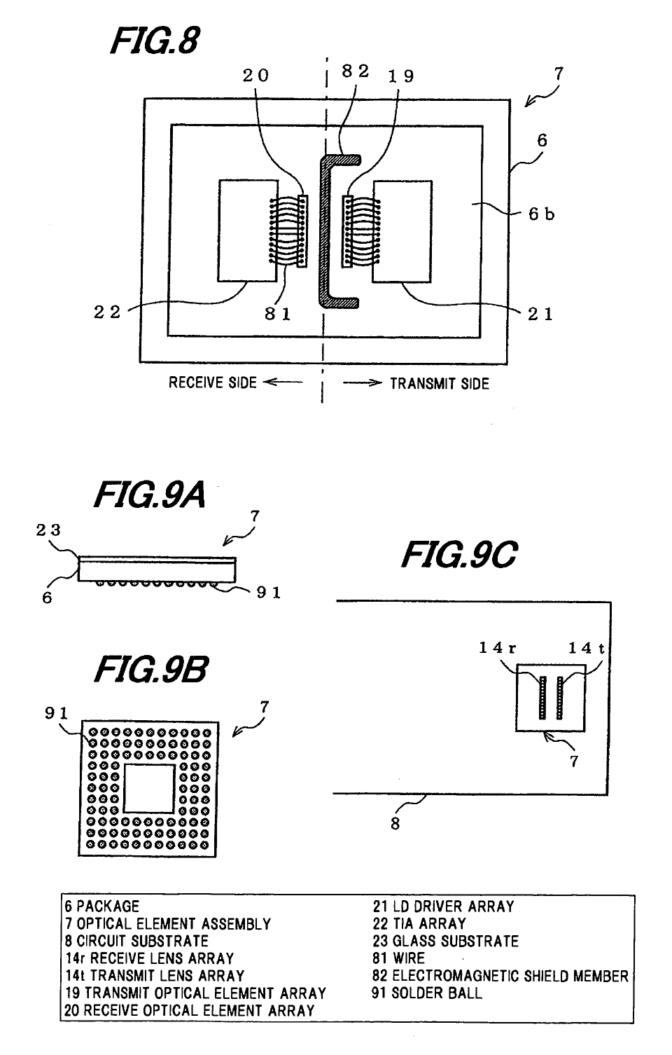

Next explained in detail is an inner structure of the optical element assembly 7 using FIG. 8.

As shown in FIG. 8, in the optical element assembly 7, on inner bottom 6b of the package 6 are mounted the transmit optical element array 19 and the receive optical element array 20 arranged opposite each other so that each transmit optical element and each receive optical element are in 2 parallel array directions. Likewise, LD driver array 21 and TIA array 22 are arranged so that their connection terminals bonded through wires 81 to each transmit optical element or each receive optical element are opposite each other.

Also, between the transmit optical element array 19 and the receive optical element array 20 is arranged a substantially U-shaped electromagnetic shield member (electromagnetic shield plate) 82 with the open transmit optical element array 19 side in a plan view. Used as the electromagnetic shield member 82 is a conductive filler-containing resin mold, or a metal mold such as Al, Zn, or the like.

Operation of this embodiment is explained.

In the optical transmission module 1 shown in FIGS. 1 and 3, twelve optical signals for each channel from the circuit substrate 8 each are converted into wavelength λ1 optical signal L1 at the transmit optical element array 19. Each optical signal L1 is converted into collimated light at the transmit lens array 14t of the optical element-side lens array 24 (in the case of the optical member 5, converted into collimated light at its transmit lens array 14t), and injected into the optical member 50. Subsequently, each optical signal L1 is reflected at the optical filter 17, collected at the lens array 14f for the fiber, emitted from the optical member 50, injected into each optical fiber 2 of the multicore fiber 3, and transmitted to another optical transmission module.

Also, twelve wavelength λ2 optical signals L2 for each channel transmitted from the other optical transmission module are emitted from each optical fiber 2 of its multicore fiber 3, converted into collimated light at lens array 14f of optical member 50, injected into the optical member 50, transmitted through optical filter 17, reflected at reflection surface 15r, and emitted from the optical member 50. Subsequently, each optical signal L2 is collected at receive lens array 14r of optical element-side lens array 24 (in the case of the optical member 5 in FIG. 1, collected at its receive lens array 14r), converted into twelve electrical signals for each channel at receive optical element array 20, and transmitted to circuit substrate 8, followed by receiving each optical signal L2 from the other optical transmission module.

The optical signal L1 emitted from the transmit optical element array 19 is reflected at the optical filter 17, substantially right-angle bent in its optical path, and optically coupled to optical fiber 2. However, because of the property of the optical filter 17, optical signal L1 injected into the optical filter 17 is partially not reflected at but transmitted and leaked through the optical filter 17.

The wavelength λ1 optical signal light emitted from the transmit optical element array 19 is substantially (not less than 95%) reflected by the optical filter 17, but slight optical signal light not reflected at but transmitted through the optical filter 17 is reflected at the MT clip 25 and again returned to the optical filter 17. The returned wavelength λ1 light again returned to the optical filter 17 is substantially (not less than 95%) reflected by the optical filter 17 and injected into the receive optical element array 20, while the remaining slight returned light is transmitted through the optical filter 17 and returned to the transmit optical element array 19. The returned wavelength λ1 light injected into the receive optical element array 20 causes noise to the original wavelength λ2 optical signals L2 to be received by the receive optical element array 20. Also, the returned light returned to the transmit optical element array 19 makes the oscillation of the transmit optical element array 19 unstable to cause excessive noise. Accordingly, the returned light causes deterioration in signal quality and is therefore undesirable. One method for avoiding these cuts wavelength λ1 optical signal L1 between the receive optical element array 20 and receive lens array 14r, and uses an optical filter with a good filter property which transmits the wavelength λ2 optical signals L2, and thereby allows suppressing leak light, but leads to high cost.

Accordingly, to overcome this problem, it is preferable, for example, to coat the backside of the MT clip 25 with a matt black paint to absorb light on the backside of the MT clip 25, or to provide micro irregularities on the backside of the MT clip 25 to scatter light on the backside of the MT clip 25. This allows leak light to be prevented from being reflected at the MT clip 25 and returned to the transmit optical element array 19 and the receive optical element array 20.

The optical transmission module 1 is equipped with the optical member 50 for receiving one set of wavelength λ1 and λ2 optical signals L1 and L2 in one optical fiber 2, and using the multicore fiber 3 comprising plural optical fibers 2 for collective multicore bidirectional communications of each optical signal L1 and L2 from the multicore fiber 3.

Because the essential part of the optical transmission module 1 is constructed by forming the lens array 14f, filter mounting portion 16, and reflective surface 15r in this optical member 50, and simply mounting one optical filter 17 on the filter mounting portion 16, the optical transmission module is simple in construction compared to conventional optical transmission modules, and can be ½ in the number of optical fiber 2 cores compared with one directional communication, and therefore small and inexpensive.

The optical transmission module 1 can have lower loss and higher reliability by providing the optical element-side lens array 24 on the backside of the glass substrate 23, and making the optical member 50 separate from the transmit lens array 14t and the receive lens array 14r which both comprise a micro-lens array.

Here, the optical member 5 comprising resin material shown in FIG. 1C causes large thermal expansion (thermal expansion coefficient 60 ppm/° C.), while the package 6 comprising ceramics causes small thermal expansion (thermal expansion coefficient 7 ppm/° C.).

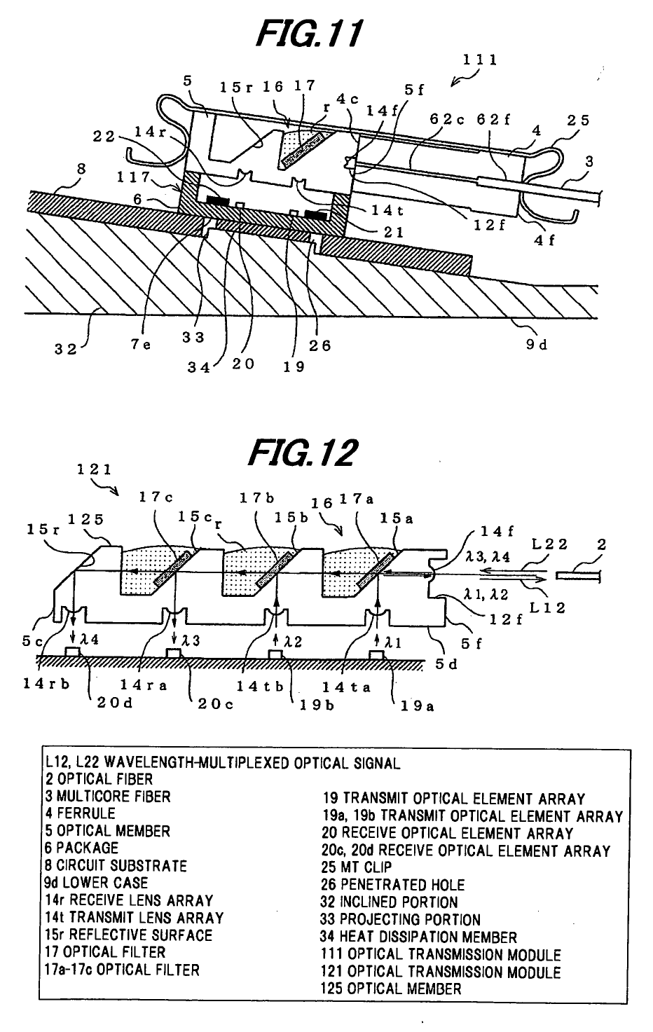

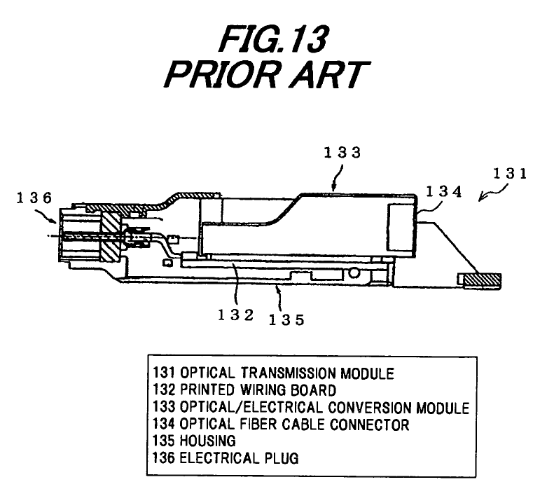

Further, in the integral structure of the optical member 5, the transmit lens array 14t and the receive lens array 14r shown in FIG. 1C, the optical member 5 is partially connected and fixed to the upper edge of the package 6, when mounting the optical member 5 on the package 6 (see FIG. 11).

For this reason, when the optical member 5 causes thermal expansion due to a temperature variation, inhibiting the thermal expansion of the large-thermal expansion optical member 5 by the small-thermal expansion package 6 has a small effect of inhibiting the thermal expansion of the optical member 5, in the structure where the optical member 5 is partially connected and fixed to the package 6.

In contrast, as shown in FIG. 3, in the structure where the optical member 50 is separate from the transmit lens array 14t and the receive lens array 14r, the entire surface opposite the lens surface of the optical element-side lens array 24 is bonded and fixed to the small-thermal expansion (thermal expansion coefficient 7 ppm/° C.) glass substrate 23.

This allows the entire optical element-side lens array 24 to be firmly bonded and fixed to the glass substrate 23 in the optical transmission module 1, and therefore inhibited from thermally expanding by the small-thermal expansion glass substrate 23.

Further, in the optical transmission module 201 shown in FIGS. 2 and 3, because the glass substrate 23 and the upper edge of the package 6 mounted with the transmit optical element array 19 and the receive optical element array 20 are sealed with resin, the contact area of the resin with outside air is very small. Therefore, because moisture invaded from the outside air into the package 6 can be decreased, it is possible to more enhance reliability of the optical elements or electronic components in the package 6.

Also, in the optical transmission module 1 shown in FIG. 1C or 10, or the optical transmission module 201 shown in FIGS. 2 and 3, by providing the inclined portion 32 in the lower case 9d, the optical member 50 or the ferrule 4 is obliquely mounted and accommodated in the module case 9, the module is not large-sized, and effective space can be ensured on the lower case 9d side.

Also, in the optical transmission module 1 or optical transmission module 201, it is possible to use this effective space for heat dissipation, or for electrical or optical component mounting on the backside of the circuit substrate 8. Accordingly, the optical transmission module 1 is easy in component mounting to the module case 9, can maintain transmission at high speed, effectively utilize the limited space within the module case 9 for 3-dimensional mounting and wiring, and compact products.

The optical transmission module 1 or optical transmission module 201 can electrically connect the connector 10 and the circuit substrate 8 without using a flexible substrate, or bending leads, as in the prior art, and allows no signal deterioration because of short electrical signal transmission paths, and further allows short connection duration.

Also, in the optical transmission module 1 or optical transmission module 201, the circuit substrate 8 on which the package 6 is positioned is provided with the penetrated hole 26 for heat dissipation. This facilitates allowing heat caused in the transmit optical element array 19, receive optical element array 20, LD driver array 21, and TIA array 22 accommodated in the package 6 to be escaped through the package 6 from the penetrated hole 26, and thereby inhibits an increase in temperature of the optical transmission module 1, and enhances reliability thereof.

In addition, in the optical transmission module 1 or optical transmission module 201, because in the penetrated hole 26, between the projecting portion 33 of the inclined portion 32 and the backside of the package 6 is provided the heat dissipation member 34 in close contact therewith, an increase in temperature is more inhibited, and the reliability is higher.

As shown in FIG. 8, in the optical transmission module 1 or optical transmission module 201, because in the package 6 are mounted the transmit optical element array 19 and the receive optical element array 20 arranged opposite each other, it is possible to prevent electromagnetic emission/injection, particularly electromagnetic emission from the transmit side to the receive side, and to be thereby robust to EMI (electromagnetic interference), compared to the case of straight line alignment of the transmit optical element array 19 and the receive optical element array 20.

The reason for mounting the transmit optical element array 19 and the receive optical element array 20 arranged opposite each other is because one row (vertical direction in FIG. 8)-arranging the receive optical element array 20 with the LD driver array 21 is likely to cause it to be affected by a magnetic field produced in the direction perpendicular to driving current of the LD driver array 21. Particularly, the driving current of the LD driver array 21 is as large as a few mA, whereas received light current is as very small as not more than a few μA, and therefore causes a large effect.

Further, when between the transmit optical element array 19 and the receive optical element array 20 is arranged the electromagnetic shield member 82, it is possible to be more robust to EMI. Particularly, to securely block electromagnetic radiation due to driving current of the transmit optical element array 19, it is desirable to form the electromagnetic shield member 82 in a U-shape.

Although in the above embodiment, the optical transmission module 1 has been explained that uses the optical member 50 separate from the transmit lens array 14t and the receive lens array 14r, an optical transmission module 111, as shown in FIG. 11 may be used that uses the optical member 5 of FIG. 1C integral with the transmit lens array 14t and the receive lens array 14r.

The optical transmission module 111 comprises an optical element assembly 117 resin-sealed by resin-coupling the peripheral edge of the planar lower surface of the optical member 5, and the upper edge of the package 6.

In this structure, because the transmit lens array 14t and the receive lens array 14r are formed integrally with the optical member 5, the optical axes of the transmit optical element array 19 and the receive optical element array 20 are aligned at a time. This facilitates optical axis alignment in the optical system.

In the above embodiment, the optical filter 17 is used that reflects wavelength λ1 optical signal L1, while transmitting wavelength λ2 optical signal L2, but may be used that transmits wavelength λ1 optical signal L1, while reflecting wavelength λ2 optical signal L2. In this case, the transmit optical element array 19 and the receive optical element array 20 may be interchanged without altering the structure of the optical member 5 or 50.

Besides, in the communication system 100 shown in FIG. 1A, where the optical transmission module 1A uses its own optical filter 17 that reflects wavelength λ1 optical signal L1, while transmitting wavelength λ2 optical signal L2 as shown in FIG. 1C, the optical transmission module 1B may use its own optical filter 17 that transmits wavelength λ1 optical signal L1, while reflecting wavelength λ2 optical signal L2, and cause its own transmit optical element array 19 to emit the wavelength λ2 optical signal, and cause its own receive optical element array 20 to receive the wavelength λ1 optical signal.

In this manner, use of the communication pair of the optical transmission modules 1A and 1B, whose respective optical members 5 each have the optical filter with wavelength transmitting and reflecting properties interchanged without altering the arrangement of the transmit and receive optical elements, allows the optical transmission modules 1A and 1B to be to driven by a common circuit system configuration, and therefore facilitates system construction.

Also, although in the above embodiment, wavelength λ1 and λ2 optical signals L1 and L2 in multicore bidirectional communications have been explained, 3 or more different wavelength optical signals may be used. In this case, because plural optical filters are necessary, the configuration of the optical member 5 or 50 may be correspondingly and appropriately modified.

For example, an optical transmission module 121 shown in FIG. 12, which is a modified example of the optical transmission module 1 of FIG. 1, may be formed with a long optical member 125 in the longitudinal direction of an optical fiber 2. 3 fiber-side inclined surfaces of 4 inclined surfaces of the optical member 125 serve as filter mounting surfaces 15a-15c, while the remaining one inclined surface serves as a reflection surface 15r. The 4 inclined surfaces correspond to 4 recessed grooves respectively formed in a lower surface 5d of the optical member 125. The 4 grooves may be provided with 2 transmit lens arrays 14ta and 14tb, and 2 receive lens arrays 14ra and 14rb respectively.

The filter mounting surface 15a is mounted with an optical filter 17a which reflects a wavelength λ1 optical signal, but which transmits other wavelength optical signals. The filter mounting surface 15b is mounted with an optical filter 17b which reflects a wavelength λ2 optical signal, but which transmits other wavelength optical signals. The filter mounting surface 15c is mounted with an optical filter 17c which reflects a wavelength λ3 optical signal, but which transmits other wavelength optical signals.

Below the optical member 125 are provided, from the fiber side, a transmit optical element array 19a for emitting a wavelength λ1 optical signal, a transmit optical element array 19b for emitting a wavelength λ2 optical signal, receive optical element arrays 20c and 20d.

This optical transmission module 121 uses 4 mutually different wavelength (λ1-λ4) optical signals in transmission between modules. The optical transmission module 121 performs transmission by wavelength-multiplexing the wavelength λ1 and λ2 optical signals emitted by the transmit optical element arrays 19a and 19b, and injecting the wavelength-multiplexed optical signal L12 (the equivalent of above-mentioned optical signal L1) into each optical fiber 2. Also, reception is performed by wavelength-separating the wavelength λ3+λ4 multiplexed optical signal L22 (the equivalent of above-mentioned optical signal L2) emitted from each optical fiber 2, and receiving them in the receive optical element arrays 20c and 20d, respectively.

The optical transmission module 121 allows higher total transmission speed of optical signals, compared to the optical transmission module 1 of FIG. 1.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. An optical transmission module, comprising:
a ferrule comprising a built-in optical fiber;
an optical member for reflecting or transmitting a plurality of different wavelength optical signals;
a first optical element for emitting an optical signal into the optical fiber via the optical member;
a second optical element for receiving an optical signal from the optical fiber via the optical member;
a package accommodating the first and second optical elements;
a circuit substrate for driving the first and second optical elements, the circuit substrate being electrically connected to the package;
a case accommodating the package and the circuit substrate; and
an inclined portion provided in an inner surface of the case, the circuit substrate
being mounted on the inclined portion.

2. An optical transmission module, comprising:
a ferrule comprising a built-in optical fiber;
an optical member for reflecting or transmitting a plurality of different wavelength optical signals;
a first optical element for emitting an optical signal into the optical fiber via the optical member;
a second optical element for receiving an optical signal from the optical fiber via the optical member;
a package accommodating the first and second optical elements;
a circuit substrate electrically connected to the first and second optical elements, the ferrule and the optical member being optically coupled each other above the circuit substrate;
a case accommodating the circuit substrate, the ferrule and the optical member, and comprising a box-type lower case with opening at a top thereof, and a sheet-type upper case for covering the opening; and
an inclined portion provided in the lower case, and the circuit substrate being mounted on the inclined portion,
wherein an optical element assembly comprising the first and second optical elements and the package is mounted on the circuit substrate, and the optical member is mounted on the optical element assembly.

3. The optical transmission module according to claim 1, wherein:
the first optical element comprises a transmit optical element array comprising a plurality of parallel-arrayed transmit optical elements for emitting optical signals injected into the optical member, and
the second optical element comprises a receive optical element array comprising a plurality of parallel-arrayed receive optical elements for receiving optical signals emitted from the optical member.

4. The optical transmission module according to claim 3, further comprising:
a glass substrate; and on the backside thereof
a transmit lens array comprising a plurality of transmit lenses formed to match an array pitch of the transmit optical element array, and a receive lens array comprising a plurality of receive lenses formed to match an array pitch of the receive optical element array,
wherein the transmit lens array, the receive lens array, the transmit optical element array, and the receive optical element array are accommodated in the package.

5. The optical transmission module according to claim 1, further comprising:
a fiber clip attached to the ferrule, and comprising an engagement groove for engaging a multicore fiber with the case, the engagement groove comprising a clearance.

6. The optical transmission module according to claim 1, further comprising:
a penetrated hole provided in the circuit substrate positioned beneath the package; and
a heat dissipation member provided in the penetrated hole and in close contact with the backside of the package.

7. The optical transmission module according to claim 3, wherein:
the transmit optical element array and the receive optical element array are arranged opposite each other and mounted in the package.

8. The optical transmission module according to claim 6, further comprising:
an electromagnetic shield member disposed between the transmit optical element array and the receive optical element array.

9. An optical patch cable, comprising:
a ferrule comprising a plurality of built-in optical fibers,
wherein optical transmission modules are optically connected via the ferrule to both ends respectively of a multicore tape optical fiber comprising a plurality of optical fibers, and
the optical transmission modules each comprise an optical member for reflecting or transmitting a plurality of different wavelength optical signals, a light-emitting element for emitting an optical signal into an optical fiber via the optical member, a light-receiving element for receiving an optical signal from the optical fiber via the optical member, a package accommodating the light-emitting element and the light-receiving element, a circuit substrate for driving the light-emitting element and the light-receiving element, the circuit substrate being electrically connected to the package, and a card edge formed at one end of the circuit substrate.

10. An optical patch cable, comprising:
a ferrule comprising a plurality of built-in optical fibers,
wherein optical transmission modules are optically connected via the ferrule to both ends respectively of a multicore tape optical fiber comprising a plurality of optical fibers, and
the optical transmission modules each comprise an optical member for reflecting or transmitting a plurality of different wavelength optical signals, a light-emitting element for emitting an optical signal into an optical fiber via the optical member, a light-receiving element for receiving an optical signal from the optical fiber via the optical member, a package accommodating the light-emitting element and the light-receiving element, a circuit substrate for driving the light-emitting element and the light-receiving element, the circuit substrate being electrically connected to the package, a card edge formed at one end of the circuit substrate, a case accommodating the package and the circuit substrate, and an inclined portion provided in an inner surface of the case, the circuit substrate being mounted on the inclined portion.
